(19) United States
(12) Patent Application Publication
(10) Pub. No.: US 2009/0120191 A1
(43) Pub. Date: May 14, 2009

(54) METHODS AND APPARATUS FOR INSPECTING FURNACE TUBES

(76) Inventors: Steven Morrison, League City, TX (US); Gershon Perelman, Cupertino, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/937,263

(22) Filed: Nov. 8, 2007

(51) Int. Cl. G01N 29/14

(52) U.S. Cl. 73/622

(57) ABSTRACT

Methods and apparatus for inspecting tubes or pipes preferably includes at least one sealed inspection pig having a length to diameter relationship based on a known bend radius of a tube or pipe to be inspected. A plurality of such pigs may be used where such pigs are interconnected, sealed, and releasable by design and where an inspection transducer is located approximately centrally between the ends of at least one of the pigs.

### BACKGROUND OF THE INVENTION

1. Field of the Invention

The present invention relates to pipe inspecting methods and apparatus. The present invention relates more particularly to inspection pig assemblies adapted to traverse relatively short radius turns in furnace tubes or other similar pipes and methods for using such assemblies.

2. Description of the Related Art

Fired heaters and furnaces used for the refinement of hydrocarbon products, such as crude oil, become scaled and dirty from the repeated high temperature processing of such materials. A high temperature can cause byproducts of the oil to become baked onto the tube walls of the furnaces. A high temperature can also accelerate corrosion of the tube walls. This scaling of the tubes or pipes impairs performance and effectiveness of the heaters and furnaces. Periodic cleaning is needed to remove this scale and dirt buildup in order to keep such heaters and furnaces running efficiently. Frequently, that is done by using a cleaning “pig” which consists of a cylindrical module that has tungsten-carbide tipped pins arranged about an outer diameter of the body of the module. The pins crack and scrape the scale off of the pipe walls as the pig is propelled through the pipe.

Side effects of this cleaning process may include reduction of pipe wall thickness due to abrasion and acceleration of corrosion due to such abrasion. There is a need to inspect and monitor these pipe walls so that they can be repaired or replaced before they become too thin and/or corroded. If a pipe wall becomes too thin, it may burst during use causing hot and hazardous materials to be expelled into the surrounding environment or undesirably intermingled.

A problem with inspecting fired heater and furnace pipes is that the constant and severe bends and turns inside the pipe make it very difficult for inspection “pigs” to navigate them, while providing accurate measurements. Further, if the inspection equipment and/or power supply carried by the pig is significant, the length of the pig can impede its progress through tight radius turns.

There is a need for an inspection “pig” that can navigate bent pipes and provide accurate detection of the corrosion and thinning of the walls. There is a further need for a “pig” that is dimensioned so that it can properly navigate furnace pipe bends. There is also a need for a “pig” having sensors configured such that accurate data may be gathered for all areas of the pipe. There is a need for an instrumented “pig” that is self contained and battery powered. There is a need for a “pig” that can be sealed in order to keep hazardous materials from damaging internal devices.

### SUMMARY OF THE INVENTION

In accordance with the present invention there is provided generally a pipe inspection system and uses including methods and apparatus for the practice thereof. More specifically, the present methods include inspecting the condition of furnace tube walls comprising the step of passing a module through a bend of a furnace tube. The method also includes the steps of emitting a first waveform from a location on the module and toward a wall of the tube and interacting the first waveform with the wall thereby generating a second waveform. Further, the method includes the steps of measuring the second waveform at the location and recording waveform measurement data.

Further, the present apparatus includes an apparatus for inspecting the condition of a furnace pipe comprising a module having a length to diameter ratio derived from a bend radius of the furnace pipe, a transducer for inspecting a pipe wall, and a data storage device.

Additionally, the present apparatus includes an apparatus for inspecting a condition of furnace pipes comprising a first module having a power system, a second module releasably coupled to the first module, the second module having a transducer for inspecting a pipe wall using acoustic waves, wherein each module is independently sealed.

### BRIEF DESCRIPTION OF THE DRAWINGS

Other objects, features, and advantages will occur to those skilled in the art from the following description of typical embodiments and from the accompanying drawings, in which:

FIG. 1 is a cross-sectional view of one embodiment of a “smart” module;

FIG. 2 is a view illustrating the components of the “smart” module;

FIG. 3 is a view illustrating the “smart” module traversing a bend in a pipe;

FIG. 3A is a view illustrating the layout of the “smart” module;

FIG. 3B is a view of the “smart” module taken along line A-A of FIG. 3A;

FIG. 4 is a view illustrating the “smart” module in a module train;

FIG. 5 is a cross-sectional view illustrating the module train;

FIG. 6 is a view illustrating an electronic module in the module train;

FIG. 7 is a view illustrating a battery module in the module train.

### DETAILED DESCRIPTION

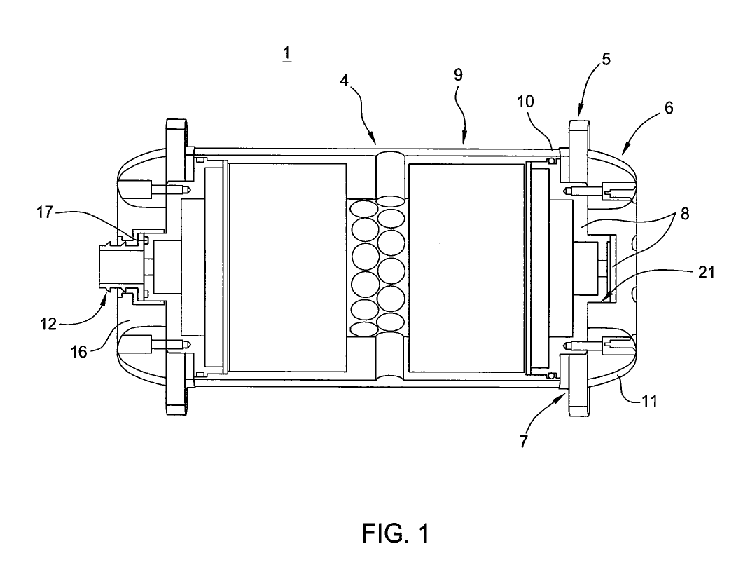

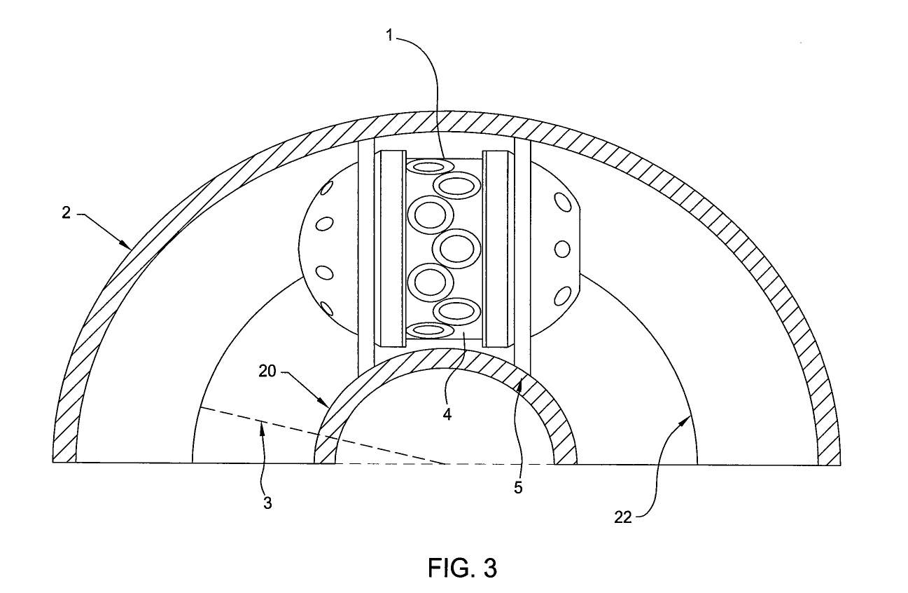

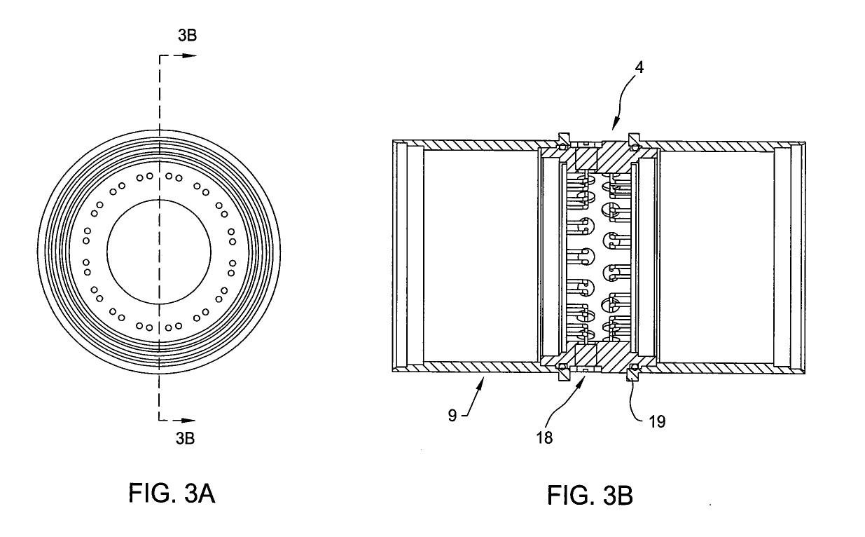

FIG. 1 shows an embodiment of a “smart” module 1 having a generally cylindrical shape that is of a calculated ratio between its length and diameter, which will be further detailed later. In the shown embodiment, the “smart” module 1 consists of a transducer array 4 such as, for example, an arrangement of sonic, ultra sonic, or other suitable generator/receivers, centrally, or approximately centrally, positioned between the ends of a body 9. Coupled to the body 9 is a connector cap 8 which has a connector cap seal 10 to prevent leakage into the body 9. Centered on the connector cap 8 are a spacer 7 and a flexible ring 5 which assists the movement of the “smart” module 1 by keeping it evenly spaced from the walls of a pipe 2 as shown in FIG. 3 and by sealing the module in the pipe 2 and capturing pressure of fluid used for moving the module through the pipe 2. The fluid in the pipe 2 may be a variety of different types of fluid, such as glycerin, oil SAE 20Fuel, oil water @ 20° C., benzene, gasoline, diesel, fuel, or other suitable fluid. The flexible rings 5 may be constructed of appropriate flexible materials such as, for example, nylon, Teflon, or urethane. An end cap 6 is coupled in this embodiment to the connector cap 8 by end cap connector screws 11. A further configuration 12 for a connector cap is shown coupled with an alternate connector coupler 16 and is sealed with a seal 17. This further configuration 12 is shown in combination with connector cap 8, but may also be used on both ends or not used on either. Connector cap seals 10 and 17 may be O-rings or another suitable seal.

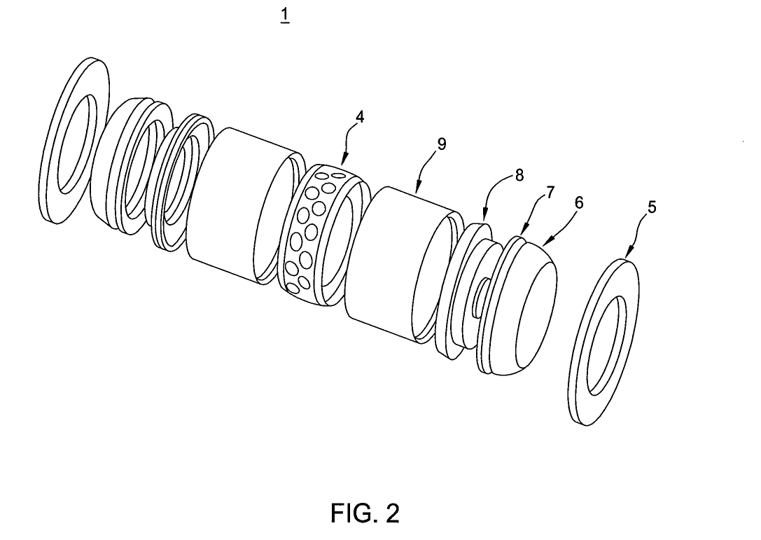

FIG. 2 shows the components of the “smart” module 1 in one embodiment and shows the transducer array 4 being separate from the body 9 where it can then be coupled and sealed with transducer array seals 19 when assembled as shown in FIG. 3A. This embodiment further comprises a flexible ring 5, end cap 6, spacer 7, and connector cap 8.

FIG. 3 depicts the movement of the “smart” module 1 through a bend in the pipe 2 of known diameter. In the shown embodiment this is accomplished by way of the flexible rings 5 and a calculated relationship of the “smart” module 1's length to its diameter. This relationship is determined based on the dimensions of the radius of bend 3 in the pipe 2 and the internal diameter of the pipe 2. The flexible rings 5 keep the transducer array 4 spaced from a pipe wall 20, and the “smart” module 1's length to diameter ratio allows it to maneuver the bend in the pipe without having its ends rub against the pipe wall 20. The pipe 2 may be made from any type of material, such as steel, CRES 400 Series Aluminum, glass, plastic, copper, PVC, composites or 2024-T4.

In one embodiment, the pipe wall thickness may be measured using the “smart” modules 1 having an acoustic transducer. One type of transducer, for example, may emit a sound wave towards a pipe wall and then measure the time it takes for the reflected incident sound wave to return. This measurement is compared to an average time, and if the measured time is longer than the average time, the pipe wall is thinner than an average pipe wall thickness. Another type may use a “ringing bell” method. This method involves emitting a sound wave with a specific frequency towards the pipe wall and measuring the frequency of the incident sound wave. The incident sound wave frequency is compared to an average frequency based on the natural frequency of the pipe and the magnitude in the difference in frequency between the average frequency and measured frequency can be used to determine the difference in thickness of the pipe wall to an average pipe wall thickness. Other transducers may be suitable such as, for example, Doppler optical, magnetic resonance, flux leakage, or any suitable combination thereof. An example of a module with a ultrasonic transducer is disclosed in U.S. Pat. No. 6,318,194, which is herein incorporated by reference.

FIG. 3A and FIG. 3B show transducers 18 arranged in the transducer array 4 in an embodiment which allows for a survey of an entire inner pipe wall 20 including through bends or turns. The transducer array 4 is placed more or less centrally to the ends of the body 9 so that incident sonic waves created by the module during the surveying of the pipe 2 are always substantially perpendicular to the pipe wall 20, shown in FIG. 3, from which they are reflecting. The transducers 18 emit sonic waves radially and receive the reflected waves radially; therefore, any offset of the reflected sonic waves would create distortion.

In one embodiment, the substantial centering of the transducers 18 between the ends of the “smart” modules 1 allows for more accurate measurements. This is of particular significance when navigating bends in pipes because it ensures that sound waves emitted from the transducers 18 are reflected perpendicular to the pipe wall 20 and right back to the transducers 18. This creates a negligible offset of the reflected sound waves from the transducers 18 as compared to mounting the transducers 18, for example, near the ends of the “smart” module 1. When the transducers are positioned near the ends of the “smart” module 1, the sound waves that are emitted hit a portion of the pipe wall 20 that is angled relative to the outer diameter surface “smart” module 1. Therefore, the reflection of the sound wave is not reflected back towards the transducer 18 from which it was emitted. Rather it is reflected off at an angle incident to the transducer 18 as dictated by the angle between the surface of the transducer 18 and the pipe wall 20. In one embodiment, keeping the “smart” module 1 evenly spaced from the pipe wall 20 is significant because it helps to keep the reflected sound waves perpendicular to the pipe walls 20 for the foregoing reasons. This spacing is provided by the flexible rings 5. The “smart” module 1 also includes several electrical components that interface with the transducer array 4.

A data storage device (not shown) such as, for example, solid state memory may be placed in the module to record the measurements taken. The “smart” module 1 typically records other data such as, for example, location so that if a corroded pipe wall is discovered, then users will know its relative location and can then repair the area before the next use of the furnace. Location data may be, for example, recorded as linear distance traveled. That distance can then be paired with wall thickness data so that damage can be located later during a repair operation, for example. The data may be analyzed with the use of a post processing software. In one embodiment, the transducer array 4 is capable of a sampling rate of 384 samples/sec per 24 UT se. In another embodiment, the transducer array 4 comprises 24 UT sensors with a frequency of 3 to 12 MHz depending on what the material is to be sampled. Each sensor has a dielectric material, such as lead niobate or other composite material. Additionally, the “smart” module 1 is generally capable of a travel velocity between 0.5 ft/sec and 4 ft/sec.

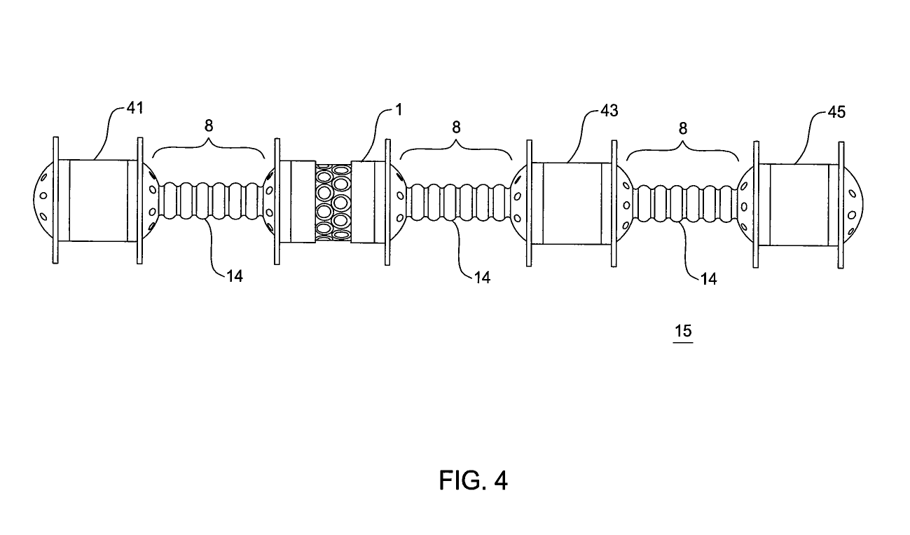

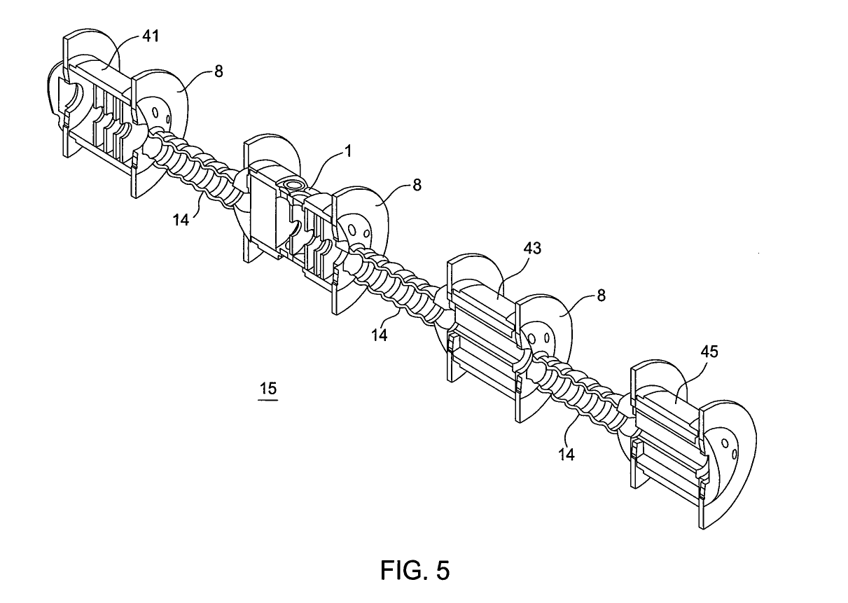

FIG. 4 and FIG. 5 illustrate a module train 15 of various modules. In one embodiment, the train 15 comprises an electronics module 41, the “smart” module 1, a battery module 43, and an end module 45. Each module is connected to another module via a sealed connector tube 14. As shown in FIG. 4 and FIG. 5, the sealed connector tube 14 is coupled to a connector cap 8. In another embodiment, the train 15 may consist of just the “smart” module 1. In a further embodiment, the train 15 optionally consists, for example, of battery or batteries, memory, computer storage units, or additional “smart” modules 1 that are connected to the “smart” module 1 via wires (not shown) in the sealed connector tubes 14. In yet a further embodiment, the train 15 may also consist of a cleaner module having scrapers, brushes, or metallic buttons, which is used to clean the pipe wall. In a typical embodiment, the sealed connector tubes 14 can be released by design if needed, and this release is detected by the other modules in the module train 15 which then relay that information to stop the movement of the module train 15 through the pipe.

In one embodiment, the modules in the module train 15 are completely sealed with seals to ensure that electrical components contained within certain modules are protected. The connection between these modules is accomplished with the use of the connector tubes 14 that create a seal when coupled to the connector caps 8. The connector tubes 14 are typically made of plastic allowing them to form to the contours of the connector caps 8 creating a seal and providing a static friction between the components. This ensures that all electrical connections are free of liquids which could impair their operation. This connection of modules may be broken as explained below. An example of this disconnection is if one of the modules becomes stuck while the other modules are still in motion. If the force created from the module being stuck is greater than that of the friction between the connector tube 14 and connector cap 8 then the connector tube 14 breaks free of the connector cap 8.

The connector tubes 14 may be released, for example, at a calculated force, wherein the force is greater than the static friction or interference at the releasable connection between the connector tube 14 and connector cap 8, and wherein the force is less than the force that would be required to pull apart the module itself. Alternatively, a suitable shearable connection such as, for example, shear screws may be used to connect an end of the connector tube 14 to the tube connecting portion 21, of the connector cap 8, such that they fail at a predetermined force thereby releasing the connector tubes 14. All of the modules are constructed using a calculated relationship, within defined parameters of length to diameter, to further facilitate movement through the pipe.

The length to diameter ratio of each module in the module train 15 is significant because it allows the body of the modules to navigate bends in pipe without deforming the modules structure. The modules can be made of any appropriate materials such as, for example, elastomer/polymers or metal. The length to diameter ratio of each module is calculated using various methods. For example, one method is to assign a value to the diameter of each module such that it is smaller than the diameter of the pipe that the module train 15 is traveling therethrough. Then subtracting the diameters and dividing by two provides an offset, wherein the offset is measured from the outermost radius of the curve in the pipe 2 and a line is formed within the curve perpendicular to the measured offset and parallel to the axis of the module. The line, intersecting the walls of the pipe (e.g. a chord presuming the curvature of the pipe to be circular) provides a distance measured between the two points of intersection, which is used to determine the length of each module. Each module should be shorter in length than this measured distance between those two points. Therefore, the smaller the diameter of each module, the longer each module can be. These length and diameter characteristics may be influenced by the size of various components such as, for example, the transducers, memory, and battery units.

Referring back to FIG. 4, another way of determining this relationship is to draw a line tangent to the centerline 22 of the bent pipe 2. The tangent will by necessity intersect the pipe wall 20 of the pipe bend in two locations. The length of each module must be less than the length of the tangent within the pipe 2 and the degree less depends on the diameter of the module, where lines parallel to the tangent can be drawn at a chosen diameter to determine the maximum length at that diameter using the criteria above, where the module should be shorter than the length of the parallel line within the pipe 2.

FIG. 5 is a cross-sectional view illustrating the module train 15. As shown, if the sealed connector tube 14 becomes disconnected from any of the modules, they do not become flooded because of the connector caps 8. This is accomplished in the embodiment by having the connector caps 8 completely solid and sealed. In this embodiment, the wires (not shown) connecting each module are connected to pins (not shown) that are embedded and sealed through the connector cap 8 which allows for complete transfer of power, data, etc. between each module, but does not allow fluid to enter any module.

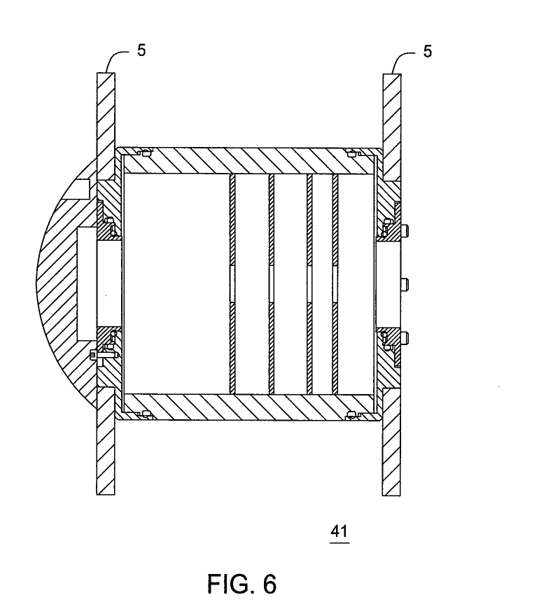

FIG. 6 is a view illustrating the electronics module 41. In a similar manner as the smart module, the electronics module 41 includes a flexible ring 5 which assists the movement of the battery module 43 by keeping it evenly spaced from the walls of the pipe.

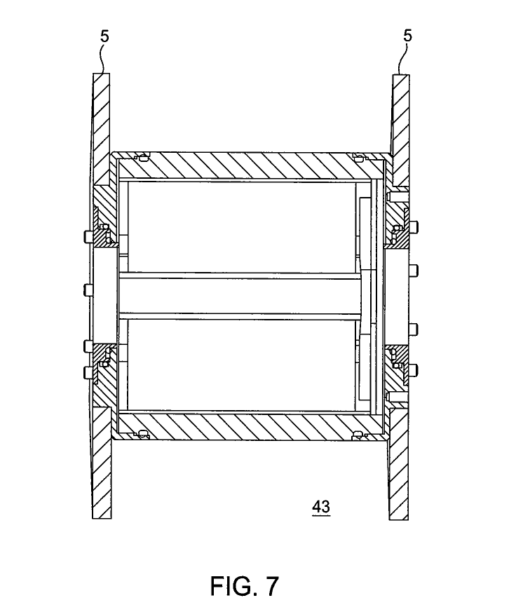

FIG. 7 is a view illustrating the battery module 43. Similar to the smart module, the battery module 43 includes a flexible ring 5 which assists the movement of the battery module 43 by keeping it evenly spaced from the walls of the pipe. The battery module 43 may comprise any type of battery element, such as a Lithium Ion element, a NiCad element, or a NiMh element.

While the foregoing is directed to embodiments of the present invention, other and further embodiments of the invention may be devised without departing from the basic scope thereof, and the scope thereof is determined by the claims that follow.

1. A method for inspecting the condition of furnace tube walls, comprising:
passing a plurality of independently sealed modules connected together through a bend of a furnace tube;
emitting a first waveform from a location on the module and toward a wall of the tube;
interacting the first waveform with the wall thereby generating a second waveform;
measuring the second waveform at the location; and
recording waveform measurement data.

2. The method of claim 1, wherein the waveform is at least one of an acoustic, optical, or electromagnetic waveform.

3. The method of claim 1, wherein the location comprises a transducer array.

4. The method of claim 3, wherein the transducer array is substantially centralized between ends of the module.

5. The method of claim 1, wherein the incident waveform is measured using a transducer array.

6. The method of claim 1, further comprising recording data corresponding to a module location within the furnace tube.

7. The method of claim 1, wherein the module has a length to diameter relationship that is derived from a bend radius of the tube being inspected.

8. The method of claim 1, further comprising releasing one of the modules from the plurality of modules when a predetermined force acts on the plurality of modules.

9. The method of claim 8, further comprising detecting the release of the module and sending a signal to the other modules to stop the movement of the modules through the furnace tube.

10. An apparatus for inspecting the condition of a furnace pipe, comprising:
a module having a length to diameter ratio derived from a bend radius of the furnace pipe, wherein an interior of the module is completely sealed;
a transducer for inspecting a pipe wall; and
a data storage device.

11. The apparatus of claim 10, wherein the module comprises a plurality of interconnected modules and each module is independently sealed.

12. The apparatus of claim 11, wherein the modules are detachably connected by at least one release member.

13. The apparatus of claim 11, further comprising a connector tube releasably connected to each pair modules.

14. The apparatus of claim 13, wherein the connector tube is configured to be released from the module without interfering with the seal of the module.

15. The method of claim 10, wherein the transducer is substantially centralized between ends of the module.

16. An apparatus for inspecting a condition of furnace pipes, comprising:
a first module comprising a transducer for inspecting a pipe wall using acoustic waves; and
a second module releasably coupled to the first module, each of the first and second modules being independently sealed.

17. The apparatus of claim 16, further comprising a sealed connection between modules.

18. The apparatus of claim 16, wherein the second module comprises at least one of a battery, a computer, a data storage device, a cleaner module, and an inspection module.

19. The apparatus of claim 16, wherein the transducer is substantially centralized between ends of the first module.

20. The apparatus of claim 16, each of the modules having a length to diameter ratio derived from a bend radius of the furnace pipe.
